(19) United States
(12) Patent Application Publication
(10) Pub. No.: US 2012/0239590 A1
(43) Pub. Date: Sep. 20, 2012

(54) MANAGING CUSTOMER COMMUNICATIONS AMONG A PLURALITY OF CHANNELS

(75) Inventors: Josef M. Broder, Ithaca, NY (US); Chitra Dorai, Chappaqua, NY (US); Anshul Sheopuri, White Plains, NY (US)

(73) Assignee: INTERNATIONAL BUSINESS MACHINES CORPORATION, Armonk, NY (US)

(21) Appl. No.: 13/047,310

(22) Filed: Mar. 14, 2011

(51) Int. Cl. G06Q 30/00

(52) U.S. Cl. 705/346

(57) ABSTRACT

A method, data processing system, and computer program product for managing communications sent to a plurality of customers are presented. A set of features of a customer in the plurality of customers and a plurality of channels for communicating with the customer are identified. A number of times to test the plurality of channels is identified based on a number of customers in the plurality of customers. A weighting for the set of features of the customer is identified from results of testing a channel in the plurality of channels. The weighting is identified in response to determining that the plurality of channels have been tested the number of times. A probability of success in using the channel to communicate with the customer is identified based on the weighting and the set of features. A determination is made whether to use the channel to communicate with the customer based on the probability.

### BACKGROUND

1. Field

The disclosure relates generally to communication management and more particularly to channels of communication. Still more particularly, the present disclosure relates to selection of channels used to communicate with customers.

2. Description of the Related Art

Businesses commonly attempt to reach out to customers through various channels of communication. A few examples of channels commonly used include telephone, electronic mail, and paper mail. Businesses may send communications to customers using one or more of these channels. The communications can include advertisements and messages. These communications may be targeted at soliciting new customers or reaching existing customers.

These attempts to reach out to the customers are either successful or unsuccessful. For example, a customer may respond to the communication or the communication may be ignored by the customer. For example, the customer may respond to the communication by purchasing a product in an advertisement or returning a message. However, if the customer does not respond to the communication the communication may be considered unsuccessful.

Methods have been employed to improve success in obtaining a response from a customer. For example, multiple communications can be sent to a single customer with the hope that the customer will respond to one of the communications. However, multiple communications to the same customer increase costs of sending communications. Additionally, a customer may ignore communications if the customer has received similar communications previously.

In other examples, businesses may send out surveys to learn customer preferences regarding communications. The information provided by customers in surveys may be helpful in determining when and how to send communications. However, obtaining information from customers in surveys requires additional communications to customers. The additional communications may not be returned. Additionally, when survey information is received from customers, the survey information is often biased.

Accordingly, it would be advantageous to have a method and system, which takes into account one or more of the issues discussed above as well as possibly other issues.

### SUMMARY

The different illustrative embodiments provide a method, data processing system, and computer program product for managing communications sent to a plurality of customers. A set of features of a customer in the plurality of customers and a plurality of channels for communicating with the customer are identified. A number of times to test the plurality of channels is identified based on a number of customers in the plurality of customers. A weighting for the set of features of the customer is identified from results of testing a channel in the plurality of channels. The weighting is identified in response to determining that the plurality of channels have been tested the number of times. A probability of success in using the channel to communicate with the customer is identified based on the weighting and the set of features. A determination is made whether to use the channel to communicate with the customer based on the probability.

### BRIEF DESCRIPTION OF THE SEVERAL VIEWS OF THE DRAWINGS

FIG. 1 is an illustration of a data processing system in accordance with an illustrative embodiment;

FIG. 2 is an illustration of a block diagram of a communication management environment in accordance with an illustrative embodiment;

FIG. 3 is an illustration of a block diagram of a channel selection system in accordance with an illustrative embodiment;

FIG. 4 is an illustration of an analysis system in accordance with an illustrative embodiment;

FIG. 5 is a flowchart of a process for managing communications sent to a customer in accordance with an illustrative embodiment; and

FIG. 6 is a flowchart of a process for identifying a channel to use in sending communications to a customer in accordance with an illustrative embodiment.

### DETAILED DESCRIPTION

As will be appreciated by one skilled in the art, aspects of the illustrative embodiments may be embodied as a system, method or computer program product. Accordingly, aspects of the illustrative embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the illustrative embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the illustrative embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the illustrative embodiments are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

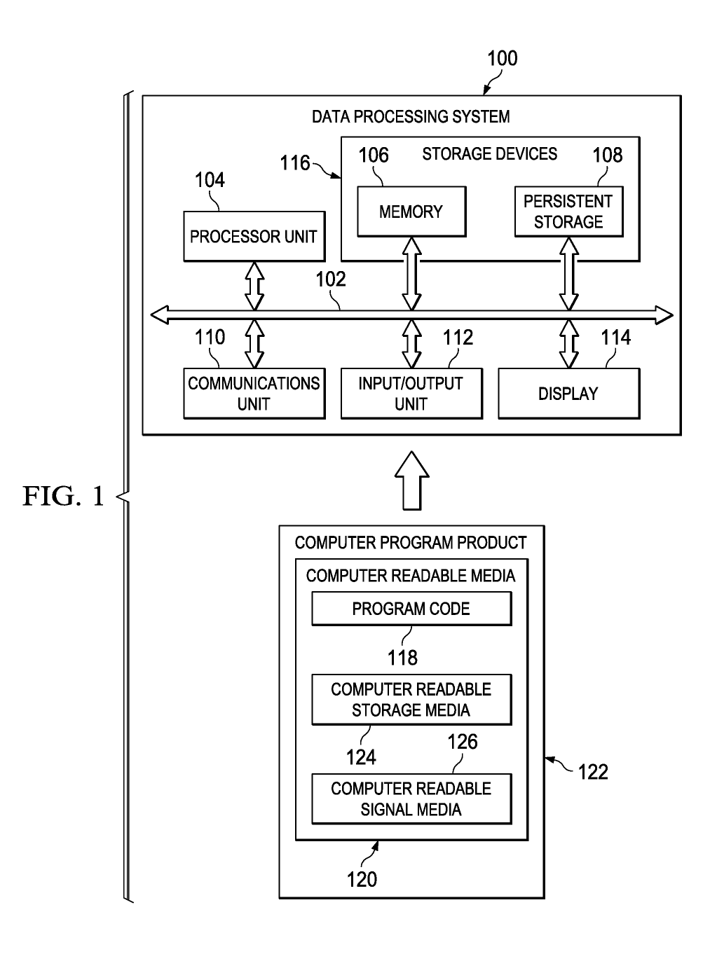

Turning now to FIG. 1, an illustration of a block diagram of a data processing system is depicted in accordance with an illustrative embodiment. In this illustrative example, data processing system 100 includes communications fabric 102, which provides communications between processor unit 104, memory 106, persistent storage 108, communications unit 110, input/output (I/O) unit 112, and display 114.

Processor unit 104 serves to process instructions for software that may be loaded into memory 106. Processor unit 104 may be a number of processors, a multi-processor core, or some other type of processor, depending on the particular implementation. A number, as used herein with reference to an item, means one or more items. Further, processor unit 104 may be implemented using a number of heterogeneous processor systems in which a main processor is present with secondary processors on a single chip. As another illustrative example, processor unit 104 may be a symmetric multi-processor system containing multiple processors of the same type.

Memory 106 and persistent storage 108 are examples of storage devices 116. A storage device is any piece of hardware that is capable of storing information, such as, for example, without limitation, data, program code in functional form, and/or other suitable information either on a temporary basis and/or a permanent basis. Memory 106, in these examples, may be, for example, a random access memory or any other suitable volatile or non-volatile storage device. Persistent storage 108 may take various forms, depending on the particular implementation.

For example, persistent storage 108 may contain one or more components or devices. For example, persistent storage 108 may be a hard drive, a flash memory, a rewritable optical disk, a rewritable magnetic tape, or some combination of the above. The media used by persistent storage 108 also may be removable. For example, a removable hard drive may be used for persistent storage 108.

Communications unit 110, in these examples, provides for communications with other data processing systems or devices. In these examples, communications unit 110 is a network interface card. Communications unit 110 may provide communications through the use of either or both physical and wireless communications links.

Input/output unit 112 allows for input and output of data with other devices that may be connected to data processing system 100. For example, input/output unit 112 may provide a connection for user input through a keyboard, a mouse, and/or some other suitable input device. Further, input/output unit 112 may send output to a printer. Display 114 provides a mechanism to display information to a user.

Instructions for the operating system, applications, and/or programs may be located in storage devices 116, which are in communication with processor unit 104 through communications fabric 102. In these illustrative examples, the instructions are in a functional form on persistent storage 108. These instructions may be loaded into memory 106 for processing by processor unit 104. The processes of the different embodiments may be performed by processor unit 104 using computer implemented instructions, which may be located in a memory, such as memory 106.

These instructions are referred to as program code, computer usable program code, or computer readable program code that may be read and processed by a processor in processor unit 104. The program code in the different embodiments may be embodied on different physical or tangible computer readable media, such as memory 106 or persistent storage 108.

Program code 118 is located in a functional form on computer readable media 120 that is selectively removable and may be loaded onto or transferred to data processing system 100 for processing by processor unit 104. Program code 118 and computer readable media 120 form computer program product 122 in these examples. In one example, computer readable media 120 may be computer readable storage media 124 or computer readable signal media 126. Computer readable storage media 124 may include, for example, an optical or magnetic disk that is inserted or placed into a drive or other device that is part of persistent storage 108 for transfer onto a storage device, such as a hard drive, that is part of persistent storage 108. Computer readable storage media 124 also may take the form of a persistent storage, such as a hard drive, a thumb drive, or a flash memory, that is connected to data processing system 100. In some instances, computer readable storage media 124 may not be removable from data processing system 100. In these illustrative examples, computer readable storage media 124 is a non-transitory computer readable storage medium.

Alternatively, program code 118 may be transferred to data processing system 100 using computer readable signal media 126. Computer readable signal media 126 may be, for example, a propagated data signal containing program code 118. For example, computer readable signal media 126 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 118 may be downloaded over a network to persistent storage 108 from another device or data processing system through computer readable signal media 126 for use within data processing system 100. For instance, program code stored in a computer readable storage medium in a server data processing system may be downloaded over a network from the server to data processing system 100. The data processing system providing program code 118 may be a server computer, a client computer, or some other device capable of storing and transmitting program code 118.

In these illustrative examples, program code 118 may be program code for managing communications sent to customers. Program code 118 may include instructions which, when executed by processor unit 104, manage the communications. For example, program code 118 may include functions for calculating a probability of success of sending the communications. In other examples, results from sending communications to customers may be stored in memory 106 and/or persistent storage 108. Program code 118 may include instructions for analyzing the results. Based on the analysis, data processing system 100 may provide recommendations for managing the communications.

The different components illustrated for data processing system 100 are not meant to provide architectural limitations to the manner in which different embodiments may be implemented. The different illustrative embodiments may be implemented in a data processing system including components in addition to, or in place of, those illustrated for data processing system 100. Other components shown in FIG. 1 can be varied from the illustrative examples shown. The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor.

In another illustrative example, processor unit 104 may take the form of a hardware unit that has circuits that are manufactured or configured for a particular use. This type of hardware may perform operations without needing program code to be loaded into a memory from a storage device to be configured to perform the operations.

For example, when processor unit 104 takes the form of a hardware unit, processor unit 104 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, programmable array logic, a field programmable logic array, a field programmable gate array, and other suitable hardware devices. With this type of implementation, program code 118 may be omitted, because the processes for the different embodiments are implemented in a hardware unit.

In still another illustrative example, processor unit 104 may be implemented using a combination of processors found in computers and hardware units. Processor unit 104 may have a number of hardware units and a number of processors that are configured to run program code 118. With this depicted example, some of the processes may be implemented in the number of hardware units, while other processes may be implemented in the number of processors.

As another example, a storage device in data processing system 100 is any hardware apparatus that may store data. Memory 106, persistent storage 108, and computer readable media 120 are examples of storage devices in a tangible form.

In another example, a bus system may be used to implement communications fabric 102 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 106, or a cache, such as found in an interface and memory controller hub that may be present in communications fabric 102.

As another example, a storage device in data processing system 100 is any hardware apparatus that may store data. Memory 106, persistent storage 108, and computer readable media 120 are examples of storage devices in a tangible form.

The different illustrative embodiments recognize and take into account a number of different considerations. For example, the different illustrative embodiments recognize and take into account that a plurality of channels exist for communicating with customers. A channel for communicating with customers is any means of sending information to a customer. For example, a channel may be telephone, electronic mail, paper mail, or a text message. A channel may also be an advertisement, such as a billboard, catalogue, and/or any other type of displayed advertisement. A channel may also be a type of advertisement such as a toy or clothing advertisement, for example. In other examples, a channel can be a type of discount on goods or services. A provider may offer a discount, such as for example, a percentage discount, a free item, such as shipping, or some other good or service, or any other type of discount. The provider may communicate this discount directly through another channel, such as for example, an advertisement, a message service, or a telephone call. Additionally, the discount may be communicated indirectly, such as by word of mouth or third party posting of the discount. Thus, the discount itself may be a means for communicating the goods or services to a customer.

The different illustrative embodiments recognize that it may be desirable to communicate with a customer using a channel that is most likely to result in a response from the customer. Communications sent using different channels of communication may have different results. For example, customers may prefer one channel over another channel. Thus, customers may respond to communications sent using preferred channels more frequently than communications sent to channels that are less preferred. Additionally, communications sent to different customers using different channels of communication may have different results. Different customers may respond differently to communication sent to the same channel.

Thus, illustrative embodiments provide a computer implemented method, data processing system, and computer program product for managing communications sent to a plurality of customers. A set of features of a customer in the plurality of customers and a plurality of channels for communicating with the customer are identified. A number of times to test the plurality of channels is identified based on a number of customers in the plurality of customers. A weighting for the set of features of the customer is identified from results of testing a channel in the plurality of channels. The weighting is identified in response to determining that the plurality of channels have been tested the number of times. A probability of success in using the channel to communicate with the customer is identified based on the weighting and the set of features. A determination is made whether to use the channel to communicate with the customer based on the probability. As used herein, a set of items means one or more items. Thus, a set of features is one or more features.

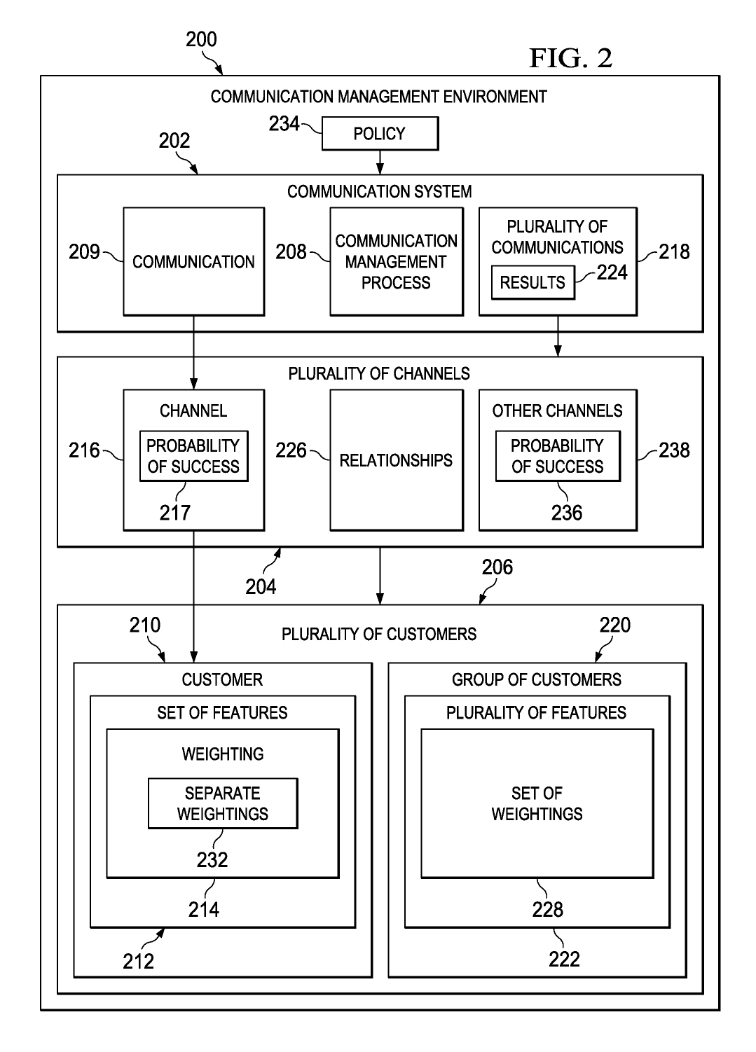

With reference now to FIG. 2, an illustration of a block diagram of a communication management environment is depicted in accordance with an illustrative embodiment. Communication management environment 200 is an environment in which illustrative embodiments may be implemented. In these illustrative examples, communication management environment 200 includes communication system 202, plurality of channels 204, and plurality of customers 206. In communication management environment 200, communication system 202 communicates with plurality of customers 206 using plurality of channels 204.

In these illustrative examples, communication system 202 includes communication management process 208 for managing communications sent to plurality of customers 206. For example, prior to sending communication 209 to customer 210, communication management process 208 identifies set of features 212 of customer 210.

In these examples, set of features 212 of customer 210 is any information about the customer that can be obtained. Features include information about the customer that describes the customer. Features also include information that could have an effect on whether the customer will respond to communications sent using a channel of communication. In theses illustrative examples, the information is information that can be used to identify a number of channels that can be used for communicating with the customer. For example, without limitation, features of a customer include age, income, credit score, payment history, previous purchases, education level, education background, gender, and/or any other features that may have an effect on the likelihood a communication will be responded to using different channels of communication. Also, in these examples, a customer is an individual that a business or organization is attempting to communicate with in hopes of receiving a response. A customer can include previous customers as well as potential customers.

Once set of features 212 has been identified, communication management process 208 identifies weighting 214 for set of features 212. In these examples, weighting 214 is a value for an amount of effect set of features 212 will have on whether customer 210 will respond to communication 209. Using weighting 214 and set of features 212, communication management process 208 calculates probability of success 217 for channel 216. In these examples, probability of success 217 is a probability that customer 210 will respond to communication 209 sent using channel 216. Communication management process 208 determines whether to use channel 216 based on probability of success 217.

In these illustrative examples, weighting 214 for set of features 212 is developed through analysis of results of previously sent communications. For example, communication 209 sends plurality of communications 218 to group of customers 220. Plurality of communications 218 is sent using one or more channels in plurality of channels 204. Communication management process 208 identifies plurality of features 222 of group of customers 220. Communication management process 208 also identifies results 224 of plurality of communications 218. In these examples, results 224 are whether or not the customer responded to the communication. For example, the customer may respond by returning a message sent in plurality of communications 218. In another example, the customer may respond to the communication by purchasing a product in an advertisement included in the communication. Communication management process 208 determines whether customers in group of customers 220 responded to plurality of communications 218 to form results 224.

For each communication sent, communication management process 208 identifies the channel used, the customer the communication was sent to, the features of that customer, and whether the customer responded to the communication. Communication management process 208 analyzes results 224 for each communication. Communication management process 208 identifies relationships 226 between features in plurality of features 222 and results 224 for a given channel.

Communication management process 208 develops set of weightings 228 for plurality of features 222 using relationships 226. For example, communication management process 208 may identify that customers having a certain feature are more likely to respond to electronic mail rather than paper mail. Based on a number of positive results for communication sent to customers with that certain feature, communication management process 208 can calculate a weighting for that certain feature. Similarly, communication management process 208 can calculate a weighting in set of weightings 228 for each feature in plurality of features 222.

Additionally, the weightings in set of weightings 228 are specific to channels within plurality of channels 204 in these illustrative examples. Continuing with the example above, a feature may have a higher weighting for communications sent using electronic mail as compared to a weighting for communications sent using paper mail. Thus, set of weightings 228 can also include a weighting specific to one or more channels in plurality of channels 204 for each feature in plurality of features 222.

Thus, when selecting channel 216 used in sending communication 209 to customer 210, communication management process 208 can identify weighting 214 from set of weightings 228. For example, weighting 214 may be a vector including a number of values for all features within set of features 212 of customer 210. Communication management process 208 identifies separate weightings 232 for each feature within set of features 212. Communication management process 208 can identify separate weightings 232 for each feature from set of weightings 228.

In these illustrative examples, communication management process 208 develops policy 234 for selecting channel 216 to use in sending communication 209 to customer 210. Policy 234 is one or more rules for determining which channel in plurality of channels 204 to use in sending communication 209. In these illustrative examples, policy 234 includes a rule for selecting channel 216 having probability of success 217 that is greater than probability of success 236 of other channels 238 in plurality of channels 204.

Communication management process 208 calculates probability of success 217 for using channel 216 to communicate with customer 210. Additionally, communication management process 208 calculates probability of success 236 for using other channels 238 to communicate with customer 210. According to policy 234, communication management process 208 will select channel 216 if probability of success 217 is greater than probability of success 236 for using other channels 238.

The illustration of communication management environment 200 is not meant to imply physical or architectural limitations to the manner in which different illustrative embodiments may be implemented. Other components in addition to and/or in place of the ones illustrated may be used. Some components may be unnecessary in some illustrative embodiments. Also, the blocks are presented to illustrate some functional components. One or more of these blocks may be combined and/or divided into different blocks when implemented in different illustrative embodiments.

For example, in some illustrative embodiments, plurality of channels 204 includes channels such as discounts and advertisements used to communicate with plurality of customers 206. For example, one channel may be a percentage discount while another channel is a free item. In another example, one channel may be a color scheme used in a catalogue while another channel is a selection of pictures for the catalogue. Communication management process 208 can calculate a weighting for features of customers based on results of communications including different types of discounts and different displays of advertisements.

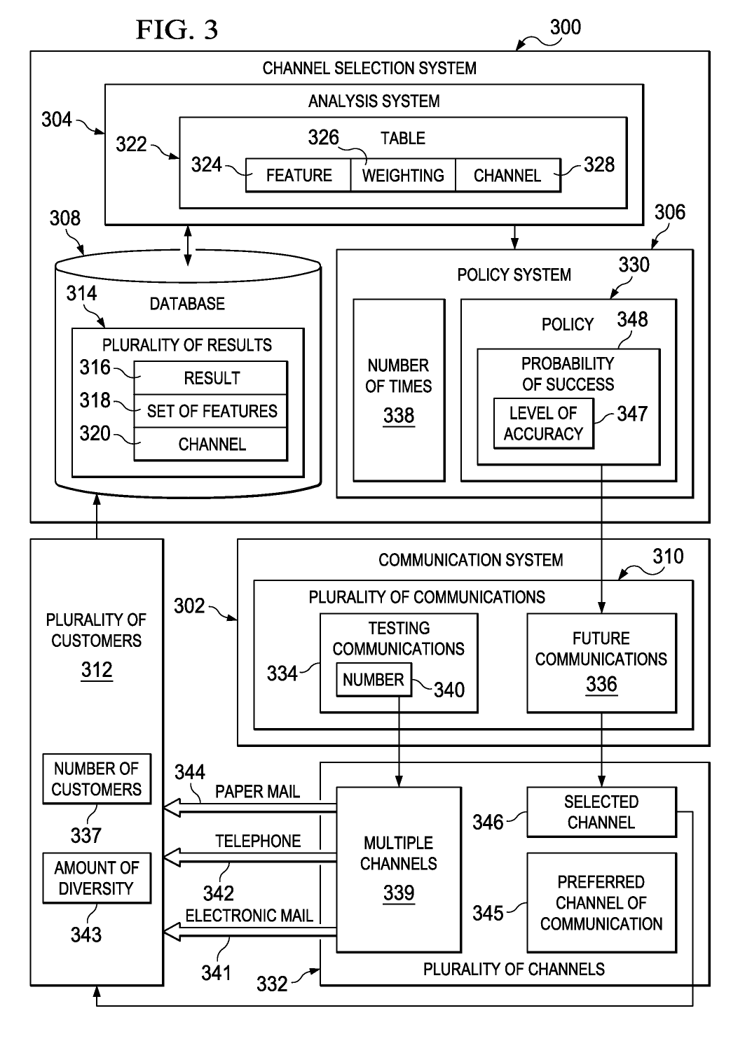

With reference now to FIG. 3, an illustration of a block diagram of a channel selection system is depicted in accordance with an illustrative embodiment. In these illustrative examples, channel selection system 300 operates in a communication management environment such as communication management environment 200 in FIG. 2. Channel selection system 300 identifies a set of channels to be used in communicating with customers. Channel selection system 300 includes analysis system 304, policy system 306, and database 308. Channel selection system 300 uses analysis system 304, policy system 306, and database 308 in identifying the set of channels.

Communication system 302 sends plurality of communications 310 to plurality of customers 312. Communication system 302 is an example of one implementation of communication system 202 in FIG. 2. In these examples, communication system 302 uses channel selection system 300 to select a channel to use in communicating with customers.

Plurality of results 314 are results from sending plurality of communications 310. Plurality of results 314 is stored in database 308. For each communication sent, result 316, set of features 318, and channel 320 are stored. Result 316 is a yes or no of whether the communication was successful. Set of features 318 is the features of the customer the communication was sent to. Channel 320 is the channel that was used to send the communication.

Analysis system 304 analyzes plurality of results 314. Analysis system 304 develops table 322 to identify relationships between features of customers and results of communications for a given channel. Analysis system 304 obtains feature 324 from plurality of results 314 and places feature 324 as an entry in table 322. Analysis system 304 develops weighting 326 that is specific to channel 328. For example, analysis system 304 obtains all results in plurality of results 314 including feature 324 and channel 328. By analyzing the results including feature 324 and channel 328, analysis system 304 can calculate an effect feature 324 has on whether the customer will respond to communications sent using channel 328.

Additionally, weighting 326 may be a function of feature 324. For example, if feature 324 is age and channel 328 is electronic mail, analysis system 304 may identify that age has an inverse effect on positive responses received using electronic mail. In other examples, analysis system 304 may identify that certain ranges of ages are more or less likely to respond to electronic mail communications. Thus, separate weightings may be included in table 322 for different ranges of features of feature 324.

In these illustrative examples, policy system 306 implements policy 330 for selecting a channel within plurality of channels 332 to use in sending plurality of communications 310 to plurality of customers 312. As illustrated, plurality of communications 310 includes testing communications 334 and future communications 336. Policy system 306 further includes number of times 338 for identifying number 340 of testing communications 334 that will be sent.

In these illustrative examples, testing communications 334 are communications sent to plurality of customers 312 to obtain test results. For example, testing communications 334 may be sent to different customers using multiple channels 339. For example, without limitation, the multiple channels 339 are electronic mail 341, telephone 342, and paper mail 344. Channels may also take other forms as discussed previously in regard to plurality of channels 204 in FIG. 2.

By sending communications using multiple channels 339, analysis system 304 identifies preferred channel of communication 345 for customers. Further, by repeating the above steps for multiple customers, analysis system 304 can develop a greater level of detail for weightings of features.

However, sending testing communications 334 on multiple channels 339 is not efficient because the channel in multiple channels 339 used may not be preferred channel of communication 345. Thus, policy system 306 includes number of times 338 for limiting number 340 of testing communications 334 are sent.

Number of times 338 may be set by an administrator or user of channel selection system 300. For example, the administrator may select number of times 338 plurality of channels 332 should be tested. Number of times 338 may be selected based on level of accuracy 347 desired in calculating probability of success 348 of future communications 336. For example, more testing communications 334 sent may result in a greater level of accuracy 347.

Factors influencing selection of number of times 338 include number of customers 337 and amount of diversity 343 of plurality of customers 312. In these examples, number of customers 337 is a total number of customers in plurality of customers 312 that are desired to be contacted using channel selection system 300. For example, as number of customers 337 increases, increasing number 340 of testing communications 334 becomes more efficient. Amount of diversity 343 is a range in the features of plurality of customers 312. For example, if customers in plurality of customers 312 have relatively similar features a lower number 340 of testing communications 334 may be efficient. However, as the amount of diversity 343 of customers in plurality of customers 312 increases number 340 of testing communications 334 may be increased to maintain desired values for level of accuracy 347. Then the administrator can establish number of times 338 in policy system 306 as number 340 of testing communications 334.

Analysis system 304 uses plurality of results 314 from the customers that were sent testing communications 334 to develop weighting. For example, analysis system 304 can use statistical models for estimating the weightings to be assigned to features of customers that have not yet been sent a communication by analyzing results from customers that have been sent a communication. One such statistical model is maximum likelihood estimation (MLE). Maximum likelihood estimation takes the mean and variance of the set of known results and produces a set of functions that are most likely to have produced those results. Thus, using the set of functions results may be estimated for weightings of customer features that have not been tested.

Once number 340 of testing communications 334 exceeds number of times 338, future communications 336 will be sent to plurality of channels 332 using only selected channel 346. Selected channel 346 is selected according to policy 330. For example, when sending a communication in future communications 336 to a customer, analysis system 304 selects a first channel in plurality of channels 332. Analysis system 304 identifies a set of features of the customer. Analysis system 304 retrieves a weighting from table 322 for each feature in the set of features of the customer specific to the first channel. Analysis system 304 then calculates the probability of success in using the first channel. The probability of success may be calculated using the following function:

P=Λ(x^{T}zₐ)

where P is the probability of success calculated; Λ is a logistics function for a sigmoid curve; x^{T} is the set of features of the customer; zₐ is the weighting for the set of features specific to channel a.

Additionally, the set of features of the customer may include more than one feature. In this case, x^{T} is a vector containing a value for each feature of the customer, while zₐ is also a vector containing a weighting for each feature in the set of features of the customer.

Once the probability of success 348 for the first channel is calculated, analysis system 304 calculates the probability of success 348 for other channels in plurality of channels 332. Selected channel 346 in plurality of channels 332 having probability of success 348 that is higher than the other channels may be selected by policy system 306 as selected channel 346.

In these illustrative embodiments, results from future communications 336 are also stored in plurality of results 314 in database 308. Analysis system 304 will continue to analyze the results from future communications 336. Thus, when a communication is to be sent to a customer, selected channel 346 is selected using weightings developed from continually updated results. As a result, the accuracy of probability of success 348 of selected channel 346 will improve overtime.

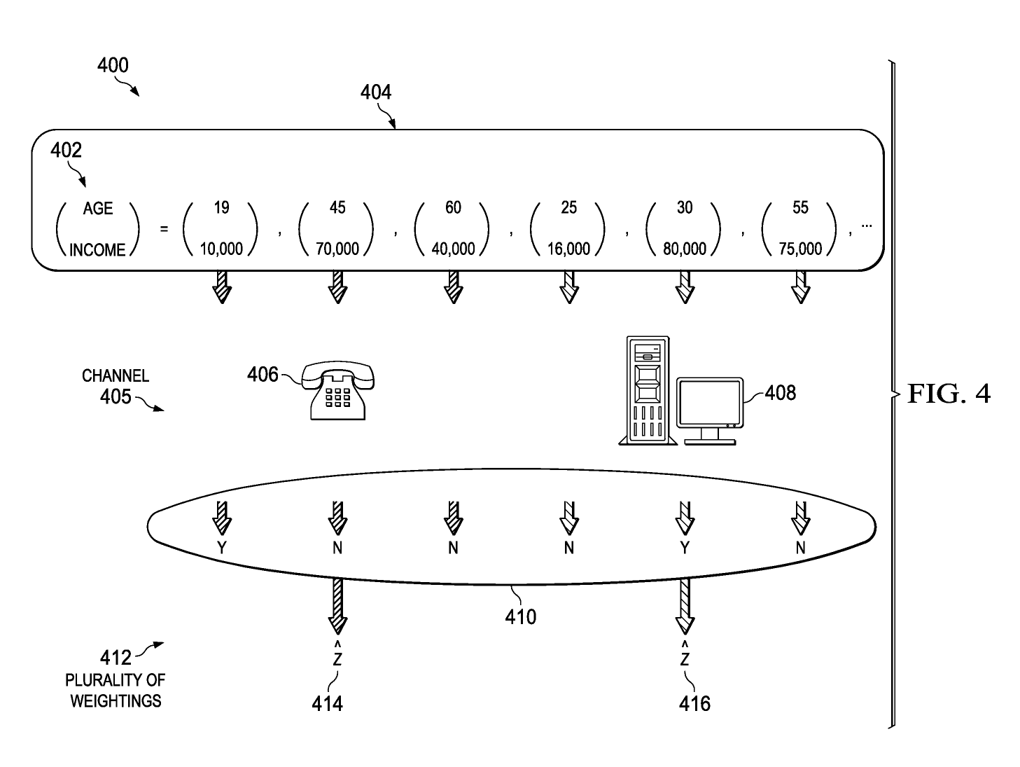

With reference now to FIG. 4, an illustration of an analysis system is depicted in accordance with an illustrative embodiment. Analysis system 400 is an example of one implementation of analysis system 304 in FIG. 3.

In this illustrative example, analysis system 400 identifies set of features 402 of plurality of customers 404. In this example, set of features 402 includes age and income. Analysis system 400 identifies a value for the age and income in set of features 402 for each customer in plurality of customers 404.

Analysis system 400 organizes set of features 402 of plurality of customers 404 according to channel 405. In this example, channel 405 includes telephone 406 and electronic mail 408. Analysis system 400 identifies plurality of results 410 from plurality of customers 404.

Analysis system 400 uses results 410 and set of features 402 of plurality of customers 404 to develop plurality of weightings 412. As illustrated, plurality of weightings 412 includes weighting 414 for telephone 406 and weighting 416 for electronic mail 408.

The illustration of channel selection system 300 in FIG. 3 and analysis system 400 in FIG. 4 are not meant to imply physical or architectural limitations to the manner in which different illustrative embodiments may be implemented. Other components in addition to and/or in place of the ones illustrated may be used. Some components may be unnecessary in some illustrative embodiments. Also, the blocks are presented to illustrate some functional components. One or more of these blocks may be combined and/or divided into different blocks when implemented in different illustrative embodiments.

For example, in some illustrative embodiments, selected channel 346 may not be the channel having a highest probability of success. For example, an organization may wish to select a single channel for communication with their entire customer base. The organization may identify features of all of their entire base customers. The organization can use weightings for those features to select a single channel for communication with their entire customer base. While the channel selected may be not have the highest probability of success for each customer, the channel selected may have the highest probability of success for their average customer.

This type of channel selection may be desirable in situations where business reasons limit the ability to use multiple channels. For example, in advertisements and displays, channel selection may be limited. In other examples, communicating using multiple channels may be costly; thus the organization may desire to establish a single channel to improve cost efficiency. In other examples, the organization may desire to use more than one channel, but fewer than the total number of channels that are available. Using more than one channel may improve the probability of success in receiving a response from a group of customers. Using fewer than the total number of available channels can improve cost efficiency. Thus, an organization may select the number of channels to use based on a balance between desired probability of success and cost efficiency.

In other illustrative embodiments, as discussed previously other channels beyond electronic mail 341, telephone 342, and paper mail 344, may be used in place of or in addition to electronic mail 341, telephone 342, and paper mail 344.

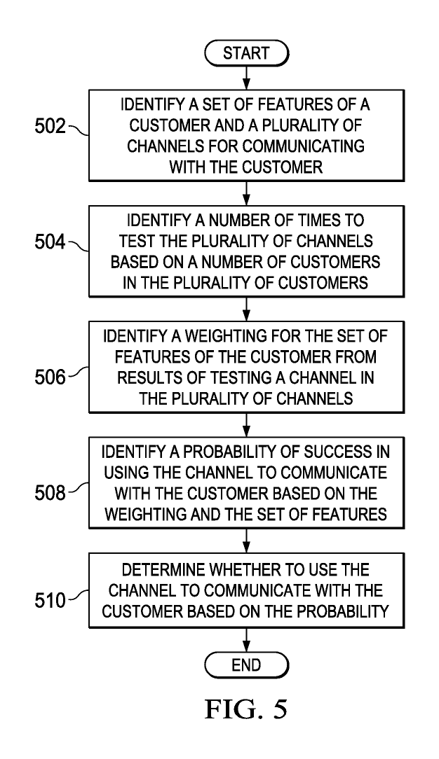

With reference now to FIG. 5, an illustration of a flowchart of a process for managing communications is depicted in accordance with an illustrative embodiment. The process illustrated in FIG. 5 may be implemented by communication management process 208 operating in communication system 202 in FIG. 2. The process also may be implemented in analysis system 304 in FIG. 3.

The process begins by identifying a set of features of a customer and a plurality of channels for communicating with the customer (step 502). Thereafter, the process identifies a number of times to test the plurality of channels based on a number of customers in the plurality of customers (step 504). In step 504, the number of times to test the plurality of channels is based on a desired level of accuracy in results of testing the plurality of channels. The plurality of channels is tested by sending communications to customers on one or more channels in the plurality of channels.

The process then identifies a weighting for the set of features of the customer from results of testing a channel in the plurality of channels (step 506). In step 506, the weighting is specific to communication using a channel in the plurality of channels. For example, a channel such as electronic mail may be selected for use in communicating with the customer. Thus, the weighting for the set of features identified would be for using electronic mail as a channel of communication with the customer. In these examples, the weighting is a vector including values for one or more features of the customer. For example, one or more features in the set of features may have separate weightings. The values for the separate weightings are included in the vector for the weighting.

Thereafter, the process identifies a probability of success in using the channel to communicate with the customer based on the weighting and the set of features (step 508). In step 508, the probability may be calculated using the weighting specific to the channel and the set of features of the customer. Then the process determines whether to use the channel to communicate with the customer based on the probability (step 510), with the process terminating thereafter. In step 510, the probability is a probability that the customer will respond to a communication sent using the channel. Different channels may have a different probability of success. The process may determine to use the channel, if the probability of success using the channel is higher a probability of success using other channels.

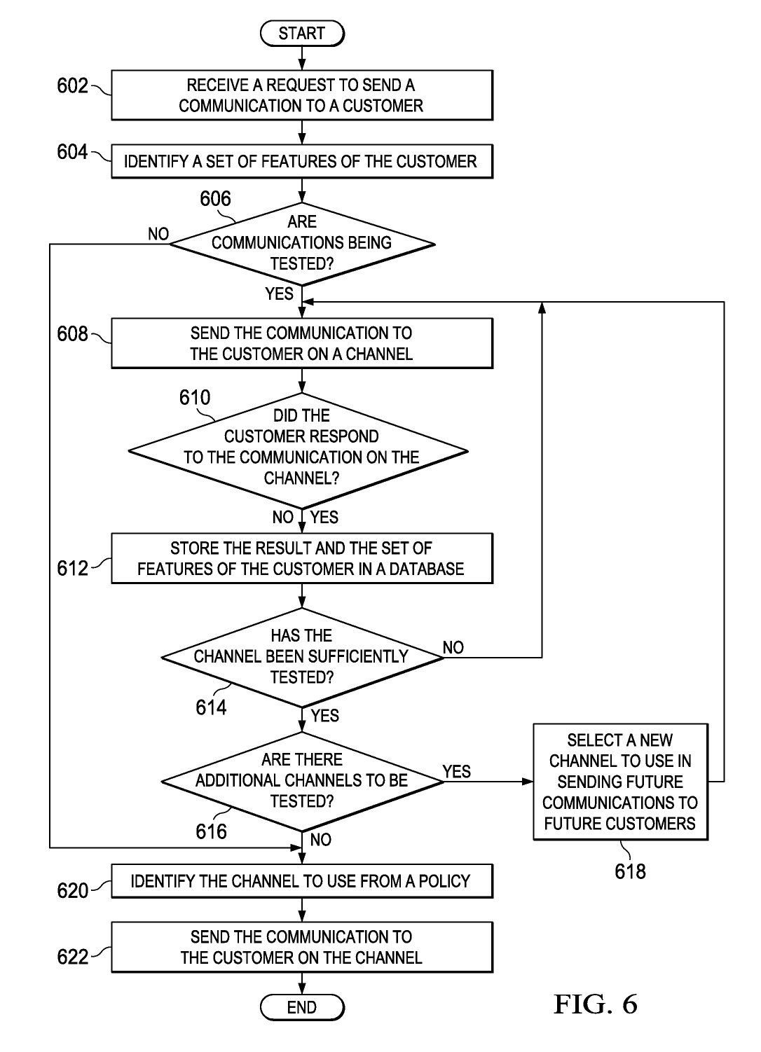

With reference now to FIG. 6, an illustration of a flowchart of a process for identifying a channel to use in sending communications to a customer is depicted in accordance with an illustrative embodiment. The process illustrated in FIG. 6 may be implemented in by communication management process 208 operating in communication system 202 in FIG. 2. The process also may be implemented in channel selection system 300 in FIG. 3.

The process begins by receiving a request to send a communication to a customer (step 602). The process then identifies a set of features of the customer (step 604). Thereafter, the process determines whether communications are being tested (step 606). In step 606, a number of customers may be explored by sending multiple communications to the number of customers on a channel. Customers are sent communications on one channel to identify the probability of success using that one channel. In other examples, customers may be sent communications on multiple channels. The number of customers to be explored depends on the level of accuracy desired in estimating the probability of success of communications sent to the customers. The number of customers to be explored may also depend on the diversity of the customers. Depending on the level of accuracy and the diversity of the customers, an administrator may select a number of times each of the channels will be used in testing communications.

If the process determines that the communications are not being tested the process continues to step 620, mentioned later. On the other hand, if the communications are being tested the process sends the communication to the customer on a channel (step 608). In step 608, the channel selected is one of a plurality of channels of communication. For example, the channel selected is a channel that has not yet been used in testing the selected number of times. The channel may be selected in a predefined order or at random.

The process then determines whether the customer responded to the communication on the channel (step 610). In step 610, the process determines the result of whether the communication was successful or not. Thereafter, the process stores the result and the set of features of the customer in a database (step 612).

The process then determines whether the channel been sufficiently tested (step 614). In step 614, an administrator may desire to test the channel a threshold number of times. The threshold number may be selected based on a desired level of accuracy and a diversity of the customers to be sent communications. If the process determines that the channel has not been sufficiently tested, the process returns to step 608 and sends communications to new customers using the channel.

On the other hand, if the process determines that the channel has been sufficiently tested, the process then determines whether there are additional channels to be tested (step 616). In step 616, the process determines whether all of the channels have been sufficiently tested. If channels are present that have not been used to send the communications to customers the threshold number of times, then the process may determine that there are additional channels be tested.

If the process determines there are additional channels to be tested, the process selects a new channel to use in sending future communications to future customers (step 618). In step 618, the new channel selected is a channel that has not been tested the desired number of times. The process then returns to step 608 and sends future communications to future customers on the new channel. On the other hand, if the process determines that there are no additional channels to be tested, the process identifies that testing of communications has concluded and proceeds to step 620 discussed below.

As discussed above, if the process determines that the communication channels are not being tested the process identifies the channel to use from a policy (step 620). In step 620, the policy specifies a channel to use in sending the communication the customer. The channel selected is based on the set of features of the customer. The process then sends the communication to the customer on the channel (step 622), with the process terminating thereafter.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The different illustrative embodiments recognize that the probability of success for communications send to customers can be calculated based on specific features of the customers. Specific channels of communication can be selected based on the features of the customers. Channels can be selected that are calculated to result in greater probability of response than other channels. Business and originations can save time and money by using a channel of communication selected for a specific customer.

Additionally, by continually updating results from communications sent, the illustrative embodiments continually improve the accuracy of the calculation of the probability of success. Overtime, business and originations can know with mathematical certainty are making correct and efficient choices in communicating with customers.

Thus, the illustrative embodiments provide a computer implemented method, data processing system, and computer program product for managing communications sent to a plurality of customers. A set of features of a customer in the plurality of customers and a plurality of channels for communicating with the customer are identified. A number of times to test the plurality of channels is identified based on a number of customers in the plurality of customers. A weighting for the set of features of the customer is identified from results of testing a channel in the plurality of channels. The weighting is identified in response to determining that the plurality of channels have been tested the number of times. A probability of success in using the channel to communicate with the customer is identified based on the weighting and the set of features. A determination is made whether to use the channel to communicate with the customer based on the probability.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the illustrative embodiments has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for managing communications sent to a plurality of customers, the method comprising:
identifying a set of features of a customer in the plurality of customers and a plurality of channels for communicating with the customer;
identifying a number of times to test the plurality of channels based on a number of customers in the plurality of customers;
responsive to determining that the plurality of channels have been tested the number of times, identifying a weighting for the set of features of the customer from results of testing a channel in the plurality of channels;
identifying a probability of success in using the channel to communicate with the customer based on the weighting and the set of features; and
determining whether to use the channel to communicate with the customer based on the probability of success.

2. The method of claim 1, wherein identifying the weighting for the set of features of the customer comprises:
identifying a plurality of features of a group of customers within the plurality of customers;
communicating with the group of customers the number of times using the plurality of channels to form a plurality of communications;
identifying relationships between a portion of the plurality of features of the group for customers and results from the plurality of communications for each channel in the plurality of channels; and
assigning a set of weightings to a portion of the plurality of features for the each channel in the plurality of channels based on the relationships.

3. The method of claim 1, wherein identifying the number of times to test the plurality of channels comprises:
identifying the number of customers in the plurality of customers, wherein the plurality of customers are a total number of customers to be sent communications;
identifying an amount of diversity in the plurality of customers; and
calculating the number of times to test each channel in the plurality of channels based on the number of customers, the amount of diversity, and a level of accuracy in calculating the probability of success.

4. The method of claim 1 further comprising:
creating a policy for selecting the channel to communicate with the customer based on the set of features of the customer, wherein the channel selected using the policy is a channel that has a probability of success that is greater than other channels in the plurality of channels given the set of features of the customer.

5. The method of claim 1 further comprising:
sending a plurality of communications to a group of customers in the plurality of customers using the plurality of channels;
identifying relationships between features of the group of customers in the plurality of customers and results from using different channels in the plurality of channels;
determining whether a number of the plurality of communications sent exceeds the number of times to test the plurality of channels; and
responsive to determining that the number of the plurality of communications sent exceeds the number of times to test the plurality of channels, creating a policy for selecting a selected channel to use in sending future communications to future customers in the plurality of customers, wherein the selected channel is selected based on the relationships between the features of the group of customers and the results from using the different channels.

6. The method of claim 5 further comprising:
sending the future communications to the future customers in the plurality of customers using the selected channel selected according to the policy; and
updating the policy based on results from sending the future communications.

7. The method of claim 1, wherein the probability of success in using the channel is a probability that the customer will respond to a communication sent using the channel.

8. The method of claim 1, wherein determining whether to use the channel to communicate with the customer based on the probability of success comprises:
identifying a probability of success for other channels in the plurality of channels; and
responsive to determining that the channel has a probability of success that is greater than a probability of success for the other channels, using the channel to communicate with the customer.

9. A computer program product for managing communications sent to a plurality of customers, the computer program product comprising:
a computer readable storage medium;
program code, stored on the computer readable storage medium, for identifying a set of features of a customer in the plurality of customers and a plurality of channels for communicating with the customer;
program code, stored on the computer readable storage medium, for identifying a number of times to test the plurality of channels based on a number of customers in the plurality of customers;
program code, stored on the computer readable storage medium, for identifying, responsive to determining that the plurality of channels have been tested the number of times, a weighting for the set of features of the customer from results of testing a channel in the plurality of channels;
program code, stored on the computer readable storage medium, for identifying a probability of success in using the channel to communicate with the customer based on the weighting and the set of features; and
program code, stored on the computer readable storage medium, for determining whether to use the channel to communicate with the customer based on the probability of success.

10. The computer program product of claim 9, wherein the program code for identifying the weighting for the set of features of the customer comprises:
program code, stored on the computer readable storage medium, for identifying a plurality of features of a group of customers within the plurality of customers;
program code, stored on the computer readable storage medium, for communicating with the group of customers the number of times using the plurality of channels to form a plurality of communications;
program code, stored on the computer readable storage medium, for identifying relationships between a portion of the plurality of features of the group for customers and results from the plurality of communications for each channel in the plurality of channels; and
program code, stored on the computer readable storage medium, for assigning a set of weightings to a portion of the plurality of features for the each channel in the plurality of channels based on the relationships.

11. The computer program product of claim 9, wherein the program code for identifying the number of times to test the plurality of channels comprises:
program code, stored on the computer readable storage medium, for identifying the number of customers in the plurality of customers, wherein the plurality of customers are a total number of customers to be sent communications;
program code, stored on the computer readable storage medium, for identifying an amount of diversity in the plurality of customers; and
program code, stored on the computer readable storage medium, for calculating the number of times to test each channel in the plurality of channels based on the number of customers, the amount of diversity, and a level of accuracy in calculating the probability of success.

12. The computer program product of claim 9 further comprising:
program code, stored on the computer readable storage medium, for creating a policy for selecting the channel to communicate with the customer based on the set of features of the customer, wherein the channel selected using the policy is a channel that has a probability of success that is greater than other channels in the plurality of channels given the set of features of the customer.

13. The computer program product of claim 9 further comprising:
program code, stored on the computer readable storage medium, for sending a plurality of communications to a group of customers in the plurality of customers using the plurality of channels;
program code, stored on the computer readable storage medium, for identifying relationships between features of the group of customers in the plurality of customers and results from using different channels in the plurality of channels;
program code, stored on the computer readable storage medium, for determining whether a number of the plurality of communications sent exceeds the number of times to test the plurality of channels; and
program code, stored on the computer readable storage medium, for creating, responsive to determining that the number of the plurality of communications sent exceeds the number of times to test the plurality of channels, a policy for selecting a selected channel to use in sending future communications to future customers in the plurality of customers, wherein the selected channel is selected based on the relationships between the features of the group of customers and the results from using the different channels.

14. The computer program product of claim 13 further comprising:
program code, stored on the computer readable storage medium, for sending the future communications to the future customers in the plurality of customers using the selected channel selected according to the policy; and
program code, stored on the computer readable storage medium, for updating the policy based on results from sending the future communications.

15. A data processing system for managing communications sent to a plurality of customers, the data processing system comprising:
a bus system;
a storage device connected to the bus system, wherein the storage device includes program code; and
a processor unit connected to the bus system, wherein the processor unit is configured to execute the program code to identify a set of features of a customer in the plurality of customers and a plurality of channels for communicating with the customer;
identify a number of times to test the plurality of channels based on a number of customers in the plurality of customers; identify a weighting for the set of features of the customer from results of testing a channel in the plurality of channels in response to determining that the plurality of channels have been tested the number of times; identify a probability of success in using the channel to communicate with the customer based on the weighting and the set of features; and determine whether to use the channel to communicate with the customer based on the probability of success.

16. The data processing system of claim 15, wherein in executing the program code to identify the weighting for the set of features of the customer the processor unit is further configured to execute the program code to identify a plurality of features of a group of customers within the plurality of customers; communicate with the group of customers the number of times using the plurality of channels to form a plurality of communications; identify relationships between a portion of the plurality of features of the group of customers and results from the plurality of communications for each channel in the plurality of channels; and assign a set of weightings to a portion of the plurality of features for the each channel in the plurality of channels based on the relationships.

17. The data processing system of claim 15, wherein in executing the program code to identify the number of times to test the plurality of channels the processor unit is further configured to execute the program code to identify the number of customers in the plurality of customers, wherein the plurality of customers are a total number of customers to be sent communications; identify an amount of diversity in the plurality of customers; and calculate the number of times to test each channel in the plurality of channels based on the number of customers, the amount of diversity, and a level of accuracy in calculating the probability of success

18. The data processing system of claim 15, wherein the processor unit is further configured to execute the program code to create a policy for selecting the channel to communicate with the customer based on the set of features of the customer, wherein the channel selected using the policy is a channel that has a probability of success that is greater than other channels in the plurality of channels given the set of features of the customer.

19. The data processing system of claim 15, wherein the processor unit is further configured to execute the program code to send a plurality of communications to a group of customers in the plurality of customers using the plurality of channels; identify relationships between features of the group of customers in the plurality of customers and results from using different channels in the plurality of channels; determine whether a number of the plurality of communications sent exceeds the number of times to test the plurality of channels; create a policy for selecting a selected channel to use in sending future communications to future customers in the plurality of customers in response to determining that the number of the plurality of communications sent exceeds the number of times to test the plurality of channels, wherein the selected channel is selected based on the relationships between the features of the group of customers and the results from using the different channels; send the future communications to the future customers in the plurality of customers using the selected channel selected according to the policy; and update the policy based on results from sending the future communications.

20. A system for managing communications, the system comprising:
an analysis system comprising a processor unit, the analysis system configured to analyze a plurality of results from sending a plurality of communications to a plurality of customers using one or more channels in a plurality of channels and identify a relationship between a set of features of a customer and a probability of success in using a channel in the plurality of channels to communicate with the customer, wherein the probability of success in using the channel is a probability that the customer will respond to a communication sent using the channel;
a policy system configured to create a policy for selecting a channel in the plurality of channels to communicate with the customer based on the set of features of the customer; and
a communication system configured to send future communications to future customers using a channel in the plurality of channels selected according to the policy, wherein the channel selected according to the policy is a channel having a probability of success that is greater than a probability of success for other channels in the plurality of channels given the set of features of the customer, wherein the analysis system includes results from sending the future communications in identify the relationship.
